(19) United States
(12) Patent Application Publication
(10) Pub. No.: US 2013/0275144 A1
(43) Pub. Date: Oct. 17, 2013

(54) SYSTEMS AND METHODS FOR BEHAVIOR ANALYSIS AND MARKET CREATION

(71) Applicant: SALUCRO HEALTHCARE SOLUTIONS, LLC, Phoenix, AZ (US)

(72) Inventor: S. Clayton Bain, Phoenix, AZ (US)

(73) Assignee: Salucro Healthcare Solutions, LLC, Phoenix, AZ (US)

(21) Appl. No.: 13/861,299

(22) Filed: Apr. 11, 2013

Related U.S. Application Data
(60) Provisional application No. 61/623,008, filed on Apr. 11, 2012.

(51) Int. Cl. G06Q 20/10; G06Q 50/22

(52) U.S. Cl. CPC G06Q 20/102; G06Q 50/22
USPC 705/2

(57) ABSTRACT

In various embodiments, the systems, methods and computer readable media (collectively “systems”) described herein are capable of requesting, collecting, and/or otherwise facilitating self-payment of healthcare related receivables. Moreover, in various embodiments, the systems may create, bundle and/or monetize and sell receivables. In various embodiments, bundles or receivables may be sold in an electronic market place. These bundles may be presented to potential buyers through a dashboard, The system may be capable of evaluating and associated a real-time value with the receivable.

### CROSS REFERENCE TO RELATED APPLICATIONS

This application claims priority to U.S. Provisional Appl. No. 61/623,008, filed Apr. 11, 2012, the entire disclosure of which is incorporated herein by reference for all purposes.

### FIELD OF INVENTION

The present disclosure relates to processing, valuation and market creation for medical payment receivables,

### SUMMARY OF THE INVENTION

In various embodiments, the systems, methods and computer readable medium (“CRM”) described herein are configured to manage payments. The computer based system may be configured to perform operations for managing payments comprising: receiving, by the computer based system, patient information; categorizing, by the computer based system, a patient profile into a predefined patient type based on at least one of the patient information and healthcare provider information; estimating, by the computer based system, a self-pay amount based on at least one of the patient information, the patient type and healthcare provider information; and requesting, by the computer based system, payment of the self-pay amount.

The computer based system may further comprise presenting a recommended strategy to capturing the self-pay amount. The computer based system may also comprise presenting payment alternatives in response to a patient not paying the self-pay amount. The computer based system may also comprise determining a value of a receivable, wherein the receivable is defined by the self-pay amount and wherein the receivable is created in response to a patient not paying the self-pay amount.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is a block diagram of various components of systems and methods configured to facilitate payment in accordance with various embodiments;

FIG. 2A is a process flow of an exemplary patient module in accordance with various embodiments;

FIG. 2B is a process flow of an exemplary patient module in accordance with various embodiments;

FIG. 3A is an exemplary screenshot of a real time valuation of a healthcare receivable in accordance with various embodiments; and

FIG. 3B is an exemplary screenshot of a dash board associated with a real time valuation of a healthcare receivable in accordance with various embodiments.

### DETAILED DESCRIPTION

The detailed description of exemplary embodiments herein makes reference to the accompanying drawings, screenshots and pictures, which show the exemplary embodiment by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The medical industry has seen a shift from insurance funded care to self-pay funded care. In the past, the self-pay portion of a hospital's revenue (e.g., the portion of revenue funded by a patient or patient affiliate for healthcare services that is not funded or covered by health insurance) was so small and so difficult to collect, that hospitals had generally ignored the self-pay portion. In recent years, self-pay has significantly increased, due to companies not offering as comprehensive healthcare plans, and wide-spread growth in health savings accounts (“HSA”) and use of flexible spending accounts (“FSA”).

This shift has caused healthcare providers (e.g., doctors, hospitals, clinics, and the like) to focus on collecting the self-pay portion of the medical bills and looking for solutions to capture the self-pay portion of a medical bill. The lack of up to date systems for self-pay, makes collecting the increased amount of self-pay very difficult. Moreover, the lack of training of hospital employees due to previously ignored self-pay, makes it very difficult to change employee behavior, especially with very poor and disconnected systems to facilitate self-pay. As such, the systems and methods described herein are configured to facilitate self pay, provide healthcare provider employees with tools to encourage and/or facilitate payment, and/or monetize receivables associated with the provision of healthcare services.

In various embodiments, the systems and methods described herein are configured to facilitate payments associated with healthcare services by providing payment vehicles that encourage patients to self-pay in a timely manner (e.g., before, at the time, or after healthcare services are rendered). The systems and methods described herein are further configured to monetize receivables associated with the provision of healthcare services to allow healthcare providers to sell off receivable that are valued based on the patient's propensity to pay or the general probability of payment. This valuation allows healthcare providers to create a marketplace for healthcare receivables. The market allows healthcare providers to improve cash flow by selling off receivables, and shifting the burden of collections to entities that are more suited for that task. Various entities may purchase the receivables through the marketplace. For example, an investment fund that is looking to deploy capital may buy a receivable or bundles of receivables at a discount over their actual value, as investments.

The systems and methods described herein may be implemented and/or deployed in any suitable fashion now known or hereinafter devised. For example, these systems and methods may include, for example, one or more firewalls, user interfaces, logins, middleware, cloud computing and/or architecture, devices, encryptions levels, and/or the like. Moreover, the systems and methods may be provided in a healthcare environment and may be configured to communicate and/or otherwise interface with various insurance computer systems, electronic medical records systems, or other suitable systems.

Phrases and terms similar to an “item” may include any good, service, medical product, medical device, medical consumable, medical service, medical procedure, information, data, content, and/or the like.

As used herein, a “patient” may include any person, company, software and/or hardware using the systems and methods described herein, including consumers of any items. For example, a patient includes any consumer of medication (e.g., over the counter medication, and/or prescription medication), supplements (e.g., over the counter supplements, and/or prescription supplements), healthcare services, a customer, an affiliate of a patient, and/or an agent of a patient (e.g., the parent of a minor patient), regardless of whether a customer doctor relationship attaches.

As used herein, a “healthcare provider” may include any person, entity, software and/or hardware that sells, prescribes, distributes, and/or recommends an item using the systems and methods described herein. For example, a “healthcare provider” includes a nurse, physician's assistant, a nurse practitioner, doctor, physician, vendor, third parties, and/or other providers of healthcare services, regardless of whether a patient-doctor relationship attaches.

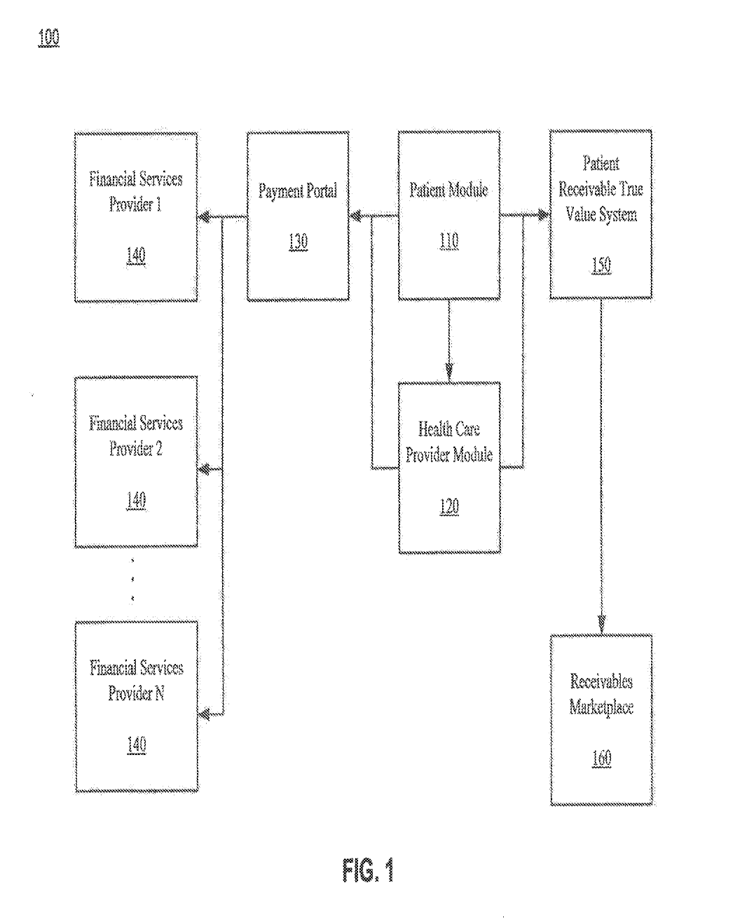

In various embodiments, and with references to FIG. 1, system 100 may be any hardware, software, or hardware/software system configured to facilitate payments for medical services. System 100 may comprise a patient module 110, a healthcare provider module 120, and a payment portal 130. System 100 may further comprise a patient receivable true value system 150. In various embodiments, the system 100 may comprise, link to, and/or otherwise be configured to provide one or more financial service providers 140. Moreover, system 100 may comprise, link to and/or otherwise he configured with a receivables marketplace 160.

Patient module 110 may be any hardware, software or hardware/software system configured to capture, monitor, analyze and/or otherwise process patient data. Patient module 110 may be configured with any acceptable user interface. The user interface may be configured to capture login data, capture, manipulate and display patient profile data, and manage other data associated with a patient. Patient module 110 may be provide information with one or more associated patients (e.g., all patients in a particular family), based on preferences or an association provided by one or more patients or one or more health care providers. Patient module 110 may be configured to present an outstanding receivable associated with a healthcare item (e.g., an doctor's office visit, a surgical procedure, a hospital visit, an emergency room visit, a clinic/urgent care visit, a prescription, a dietary supplement, a medical device, and/or the like) to a patient before, during, or after the provisioning of the item.

Patient module 110 may be in communication with one or more financial service providers 140. One or more financial service providers 140 may be associated with a particular patient and displayed through patient module 110 based on the activities of the associated patient, the creditworthiness of the patient, the preferences of an associated healthcare provider, the insurance coverage associated with a patient, and/or the like.

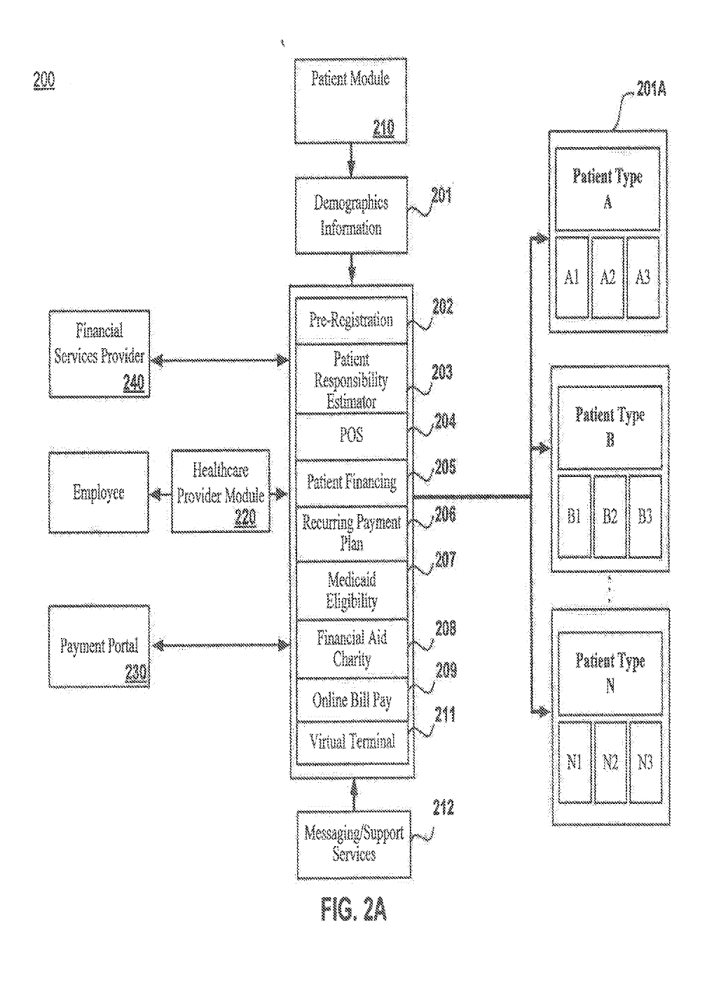

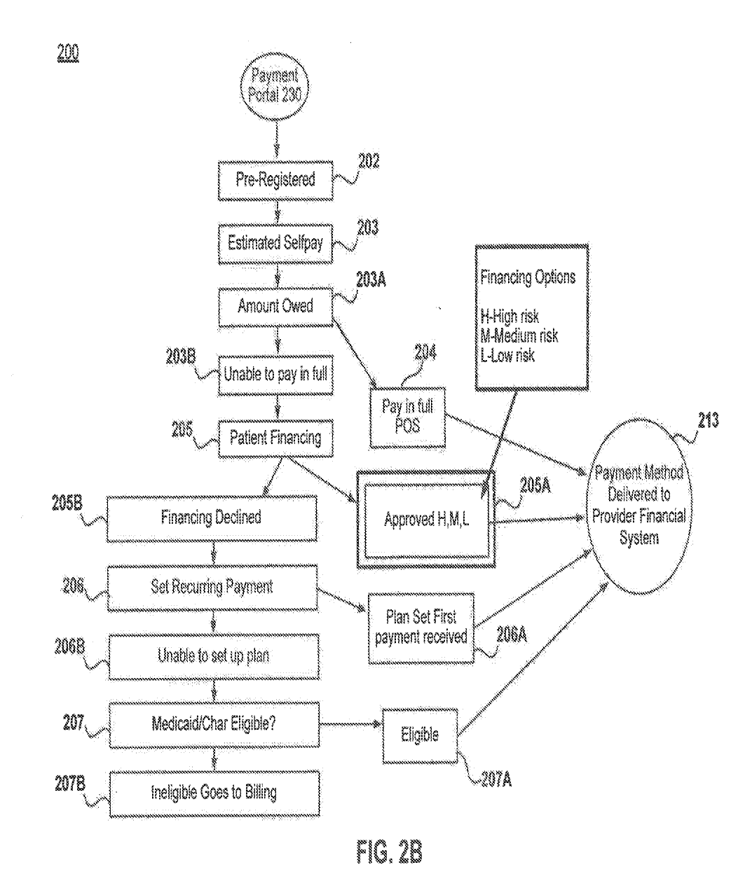

In various embodiments, and with reference to FIG. 2A and FIG. 2B, prior to or at the time of a visit, the patient may access patient module 210. The patient may provide patient module 210 with demographic information, which is used to create a patient profile (Step 201). The demographic information may include, for example, gender, ethnicity, contact information, income information, employment information, insurance information, transaction account information, and/or the like. The information may be associated and/or stored with a patient profile.

The patient may pre-register with the healthcare provider (Step 202). Prior to the visit, at the time of the visit or prior to receiving healthcare services. Access to patient module 210 may be provided by a healthcare provider through an employee, a kiosk, 3rd party vendor or other suitable system. Pre-registration may also be provided by a third party (e.g., an insurance plan or receivable management company). Based on the patient profile information and/or the pre-registration information, the patient may in placed into a predetermined patient type 201A. Patient type 201A may comprise one or more populations of similarly situated patients.

In response to the pre-registration, payment portal 230 may be configured to estimate the total cost of an item and apportion responsibility to the entities responsible for payment (e.g., the patient and the insurance company associated with the patient) (Step 203). The estimation may be based on various factors including the patient profile, inputs provided by the health care provider, and the like. The patient may be presented with a point of sale (“POS”) feature to provide payment for the self-pay portion (e.g., the amount of the payment for which the patient is responsible). An employee of a healthcare provider may also be presented with a POS feature or a prompt that is configured to provide the employee with information designed to assist the employee in capturing the self-pay portion of the payment based on the patient type 201A. Where the patient is able to provide payment, the patient and/or employee provides the POS feature with transaction account information to pay the self-pay portion. It should be noted that the POS feature may be displayed before, during or after the item has been provided to the patient. Moreover, the systems and methods described herein are configured to capture payments early in the healthcare process and pre-payment for service is advantageous, the system can capture payments at any time.

Where the patient is unable or unwilling to provide payment for the self-pay portion, the payment portal 230 is configured to provide one or more payment options based on the profile 201, the patient type 201A, suggestions (e.g., prompts) provided to an employee, and/or the like. For example, payment portal 230 may be configured to provide access to one or more financial service providers 140. Financial service provider 140 may be configured to provide patient financing options based on the patient profile 210, the patient type 201A, and/or other factors (Step 205).

For example, financial service provider 140 and/or payment portal 130 may be configured to provide or determine whether a patient is eligible for one or more payment options including patient financing 205, a recurring payment plan 206, Medicaid eligibility 207, financial aid/charity 208, online bill pay 209, and/or virtual terminal 211. These various payment options may be presented by the employee or directly to the patient via the POS, patient module 210 or any other suitable system.

Patient financing 205 may include any suitable type of financing provided by a third party. For example, the system may contract with one or more third party financing companies including, for example, BillMeLater®, a bank, or any other suitable entity capable of financing medical expenses. Moreover, the healthcare provider employee may be provided with a suggested strategy to secure payment from the patient based on the patient profile 201 or patient type 201A.

Recurring payment plan 206 may be offered by the healthcare provider in order to induce payment by particular patients. Generally, the healthcare provider would only offer this option to patients that do not qualify for financing or pay in full. For example, based on patient profile 201 and patient type 201A, a particular patient may be unable or unwilling to pay an entire payment amount at the time an item is provided to the patient. In this situation, the employee may be provided with a strategy that allows the patient to make an initial payment and make predefined recurring payments until the entire amount is satisfied. The recurring payment may be structured in any suitable fashion. For example, the recurring payment may be defined with terms that require a particular level of initial payment, a fee associated with electing this option, and/or an automatic debit from a transaction account associated with the patient and/or the like.

Medicaid eligibility 207 may be defined based on parameters associated with patient profile 201 or patient type 201A. This eligibility may be determined in real time based on inputs provided by the patient and/or employee. Eligibility may also be predetermined based on elections or information associated with a particular patient profile 201 or patient type 201A.

Similarly, financial aid/charity 208 may be available based on parameters associated with patient profile 201 or patient type 201A. Moreover, a particular healthcare provider, particular health items, or a particular patient may be eligible for financial aid/charity 208. For example, a healthcare provider may affiliate with a particular charity, state, or federal charity program to combat a predetermined illness, or a particular drug manufacturer may offer aid to particular patients based on particular illnesses and a prequalification process.

Online bill pay 209 may be offered to particular patients based on patient profile 201 or patient type 201. For example, where a patient is a minor child, but has an associated parent patient affiliate that has paid the self-pay portion of the patient's medical expenses in the past, the patient may be provided with the option for online bill pay. Typically, online bill pay defers collection of the self-pay portion, while responsibility for the self-pay portion remains with the patient and/or affiliate. As such, the employee may be prompted to suggest other payment options to insure that responsibility for the payment shifts to increase the likelihood of collection of the self-pay portion.

Virtual terminal 211 may be offered to particular patients based on a particular payment vehicle presented by the patient. For example, where the patient has an electronic device (e.g., a smart phone or RF fob) configured with a payment protocol, but is unable to pay through a traditional payment terminal; virtual terminal 211 may be provided to the patient to secure payment for the self-pay amount.

In various embodiments and with momentary reference to FIG. 2B, healthcare providers, patients, and or a third party may pre-rank or define a preferred payment acquisition strategy through payment portal 230. For example, system 200 may be configured to estimate the self-pay portion of the healthcare expense (Step 203) and the amount owed by the patient (Step 203A). In response to setting the amount owned by the patient, system 200 may then determine whether the patient is capable of paying an amount owed in full. If the patient is able to pay the self-pay amount, the patient is provided by a POS and payment is collected using any suitable method (Step 204). System 200 may be configured with various payment options including, for example, online payment, credit card payment, cash payment, check or electronic check payment, Paypal®, virtual terminal payment, and/or the like. System 200 may also determine that the patient is not able to pay the self-pay amount in full (Step 203B).

In response to the patient not being able to pay the self-pay amount in full, system 200 may be configured to attempt to process a payment based on a predefined payment strategy. The system may be configured to present various payment options in any order or in a predefined order based on the preferences of a healthcare provider using system 200. In various embodiments, and in response to the patient not being able to pay the self-pay amount in full, system 200 may initially present patient financing (Step 205). System 200 may be configured to evaluate the particular circumstances surrounding payment for the particular patient to determine whether financing is available for the patient's self-pay portion and if financing is available the level of risk associated with providing financing to the particular patient (Step 205A). Various factors may be used to determine risk. For example, the risk determination may be based on the creditworthiness of the patient, the job and/or income history of the patient, and/or the amount of the self-pay portion. The risk may be quantified on any suitable scale including, for example, high (“H”), medium (“M”), and/or low (“L”) or any other suitable scale. Based on the risk and/or particular circumstances of a patient or self-pay amount, system 200 may also decline to finance a particular self-pay amount (Step 205B).

In response to the financing being declined, system 200 may be configured to offer the patient a recurring payment (Step 206). Where system 200 approves the recurring payment, the plan may be established with pre-determined payment parameters and a first payment may be provided (Step 206A). System 200 may make the recurring payment determination based on various parameters including creditworthiness of the patient, the job and/or income history of the patient, the amount of the self-pay portion, and/or the like. If system 200 is unable to establish a recurring payment plan (Step 206B), system 200 may be configured to determine whether the patient is eligible for Medicaid or charity contributions to satisfy the self-pay amount (Step 207). Where the patient is eligible, thuds from Medicaid and/or the charity are associated with the self-pay amount (Step 207A). Where no alternative payment scheme is available to the patient for the self-pay amount, the receivable may be sent to a billing or collection department for further processing or collection (Step 207B).

Any of the payment scenarios described above, may be presented in any order based on the preferences of the particular health care provider. Moreover, these payment scenarios may be used in combination in order to satisfy any self-pay amount. Each of the payment scenarios may be administered by the healthcare provider or by one or more third parties.

Moreover, where a payment strategy is approved and/or accepted for the self-pay amount, the payment method and/or funds associated with the self-pay amount may be delivered to the healthcare provider financial system 213. The delivery of the payment method and/or funds may also shift responsibility for collection of the receivable from the healthcare provider to a third party, thus improving the revenue generation associated with a self-pay amount to the healthcare provider.

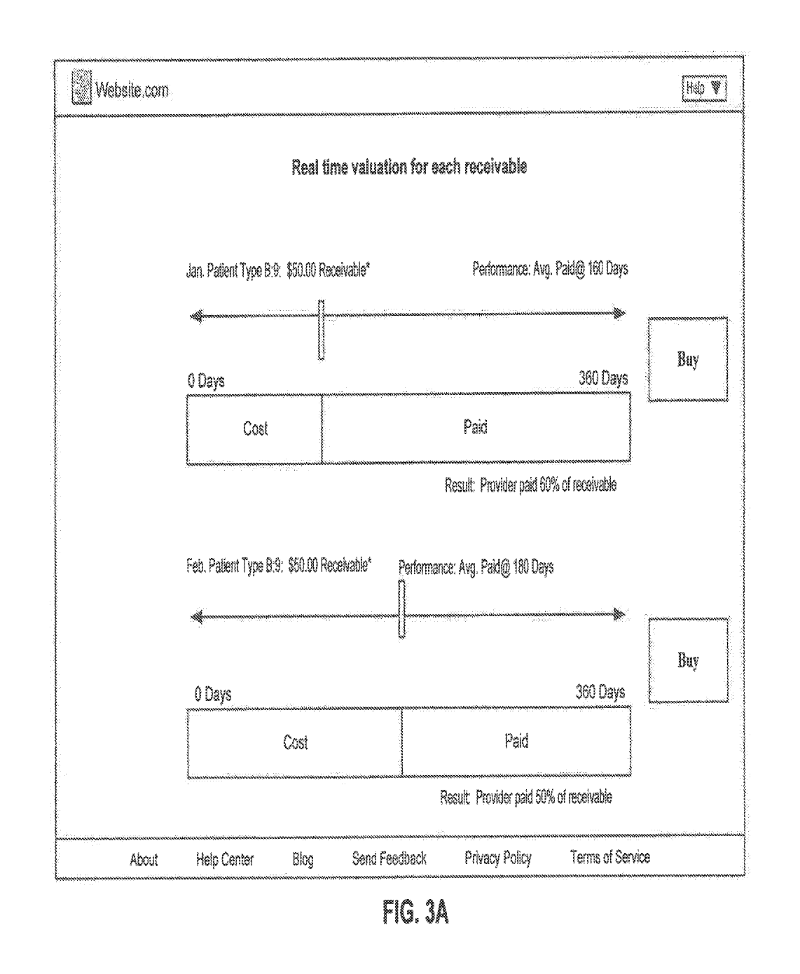

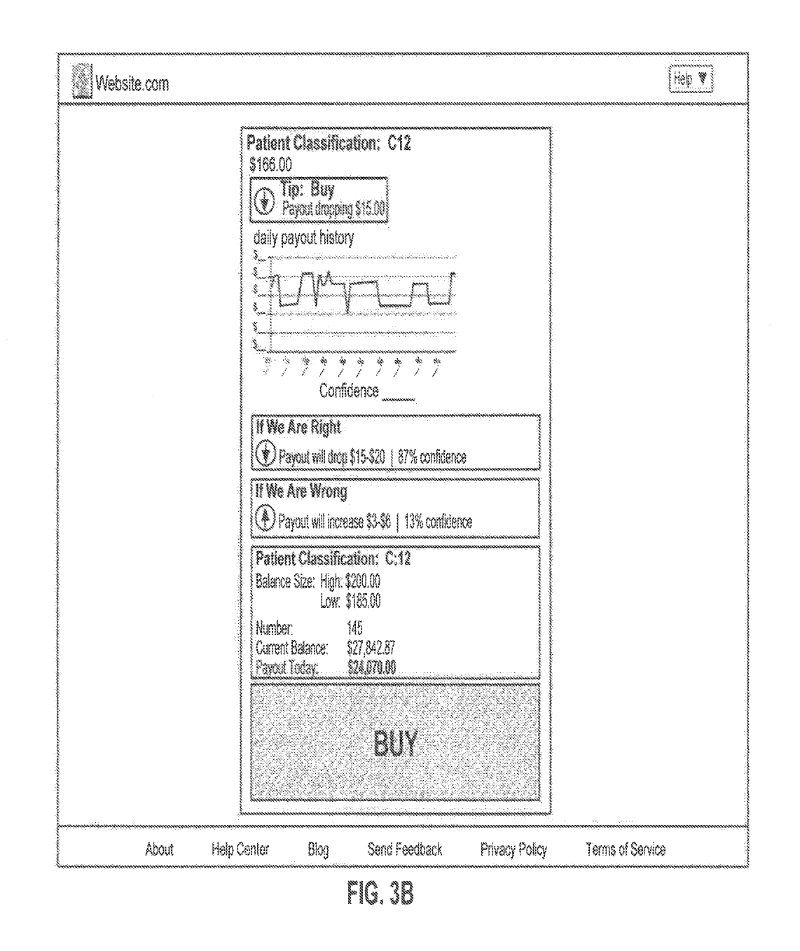

In various embodiments and with reference to FIG. 3A and FIG. 3B, the system may be configured to monetize outstanding healthcare provider receivable associated with the self-pay amount. In various embodiments, the system may be configured to create a real time valuation for each receivable. This real time valuation may be based on any suitable method. For example, the valuation may consider factors such as, for example, the amount of the receivable, activity associated with the market place where the receivable is being sold, payment performance on the receivable, past payment performance of a receivable, payment resource preference, performance of the patient classification in other entities, and/or the like. The system may further be configured to provide a marketplace (e.g., an electronic marketplace) for the various receivable that includes functionality that allows a purchaser to compare and buy one or more of the receivables. The cost and value of the receivable may be based on the real-time valuation or may be discounted a predetermined or dynamically determined amount. The discount may be dynamically determined based on the inventory of receivable associated with a particular healthcare provider, the volume or receivables purchased, prior receivable purchase history, or any other suitable method.

In various embodiments, and with specific reference to FIG. 3B, the system may be further configured with a receivable dashboard. The dashboard may be available to any suitable user (e.g., a buyer, seller, or third party). The dashboard may comprise elements that allow a user to sell, purchase, and/or further evaluate the receivable. For example, the dashboard may comprise a payment confidence associated with a receivable or a lot of receivables. The confidence level may be determined based on the payment history of the patient associated with the receivable, the amount of time the receivable has been outstanding and/or other suitable factors. The confidence level may also provide the purchaser with an expected value of the receivable and/or a recommendation whether to buy the receivable. The dashboard may comprise a sell and/or buy button allow a user to easily sell or buy the receivable. The dashboard may also comprise receivable portfolio data. For example, the dashboard may include the total number of receivable available in a particular portfolio, the current balance associated with the receivables in a portfolio (e.g., the amount a patient owes for each receivable), and the payout balance (e.g., the amount to advance the funds for the associated receivable). Once a purchase transaction for a receivable is initiated or completed, the system may be configured to automatically debit the purchasers account for an amount associated with the purchase of the receivable. The system may further be configured to post changes to the patient account associated with the receivable as a result of the purchase.

In various embodiments, the portfolio may be defined in any suitable fashion. For example, the portfolio may be defined based on a particular patient type, patient propensity to pay, a medical procedure type or any other suitable category. Various portfolios may also have various associated fees, further defining the payout balance for a particular portfolio. For example, the associated fees may be based on the number of receivables in a particular portfolio, the amount of the current balance, and/or any other suitable factor.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that Many alternative or additional functional relationships or physical connections may be present in a practical system.

The various system components discussed herein may include one or more of the following: a host server or other computing systems including a processor for processing digital data a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include; client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including hap, https, ftp, and sftp.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhoneS, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DilipNaik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Tatty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DK), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NISI's (National Institute of Standards and Technology) definition of cloud computing at http://csrc.nist.gov/groups/SNS/cloud-computing/cloud-def-v15,doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables, Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, POP, PM, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to farther enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internetb A firewall may be integrated as software within an Internet server, any other application server components or may reside within another computing device or may take the form of a standalone hardware component.

The computers discussed herein may provide a suitable website or other Internet based graphical user interface which is accessible by users. In one embodiment, the Microsoft Internet Information Server (HS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems, Middleware components are commercially available and known in the art. Middleware may be implemented through commercially available hardware and/or software, through custom hardware and/or software components, or through a combination thereof Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley &. Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference,

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tablets, kiosks, desktop computers, tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the Internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article, of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable: medium” should be construed to exclude only those types of transitory computer-readable media which were found in In ReNuijtento fall outside the scope of patentable subject matter under 35 §101.

Phrases and terms similar to an “entity” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, hank account, prepaid account, telephone card, embossed card, smart card, magnetic stripe card, bar code card, transponder, radio frequency card or an associated account.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more,” Moreover, where a phrase similar to at least one of A, B, and C or at least one of A, B, or C is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims, Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for,” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1-5. (canceled)

6. A method, comprising:
creating, by a computer based system for managing payments, a patient profile ire response to receiving patient information;
categorizing, by the computer based system, the patient profile into a patient type based on at least one of the patient information and healthcare provider information;
estimating, by the computer based system, a self-pay amount in response to an item being associated with the patient profile and based on the item and at least one of the patient information, the patient type and healthcare provider information; and
requesting, by the computer based system, payment of the self-pay amount.

7. The method of claim 6, further comprising presenting, by the computer based system, a recommended strategy for capturing the self-pay amount.

8. The method of claim 6, further comprising presenting, by the computer based system, payment alternatives in response to a patient not paying the self-pay amount.

9. The method of claim 6, further comprising determining, by the computer based system, a value of a receivable and wherein the receivable is defined by the self-pay amount.

10. The method of claim 9, wherein the receivable is created in response to a patient not paying the self-pay amount.

11. The method of claim 9, wherein the receivable is created in response to a timeframe.

12. The method of claim 11, wherein the timeframe is associated with an estimated time for a patient to pay the self-pay amount.

13. The method of claim 9, wherein a plurality of receivables are stored in the computer based system.

14. The method of claim 13, wherein the plurality of receivables are associated into one or more groups.

15. The method of claim 14, further comprising calculating, by the computer based system, a monetary value for a first group of the one or more groups.

16. The method of claim 15, wherein the calculating considers the self-pay amount for each of the plurality of receivables associated with the first group.

17. The method of claim 15, wherein the calculating considers the timeframe for each of the plurality of receivables associated with the first group.

18. The method of claim 15, further comprising transmitting, by the computer based system, listing instructions for the first group to an electronic marketplace.

19. The method of claim 18, wherein the listing instructions include a summary of the first group and an offer amount.

20. The method of claim 19, wherein the offer amount is associated with the monetary value.

21. The method of claim 19, wherein the offer amount is a predetermined percentage of the monetary value.

22. The method of claim 19, wherein the offer amount is a dynamically determined percentage of the monetary value based on an activity associated with the electronic marketplace.

23. The method of claim 18, wherein the electronic marketplace comprises a dashboard that displays a summary of the first group and an offer amount for the first group.

24. A non-transitory computer program product having computer-executable instructions stored thereon that, if executed by a computer based system for managing payments, causes the computer based system to be capable of performing operations comprising:
creating, by the computer based system, a patient profile in response to receiving patient information;
categorizing, by the computer based system, the patient profile into a patient type based. on at least one of the patient information and healthcare provider information;
estimating, by the computer based system, a self-pay amount in response to an item being associated with the patient profile and based on the item and at least one of the patient information, the patient type and healthcare provider information; and
requesting, by the computer based system, payment of the self-pay amount.

25. A system comprising:
a processor for managing payments;
a network interface communicating with a memory;
the memory communicating with the processor, the processor when executing a computer program, is configured to perform operations comprising:
creating, by the processor, a patient profile in response to receiving patient information;
categorizing, by the processor, the patient profile into a patient type based on at least one of the patient information and healthcare provider information;
estimating, by the processor, a self-pay amount in response to an item being associated with the patient profile and based on the item and at least one of the patient information, the patient type and healthcare provider information; and
requesting, by the processor, payment of the self-pay amount.
